(19) United States
(12) Patent Application Publication
(10) Pub. No.: US 2025/0063004 A1
(43) Pub. Date: Feb. 20, 2025

(54) PERSONALIZED AVATAR DESIGN IN CHATBOT

(71) Applicant: Jia Xu, Hoboken, NJ (US)

(72) Inventor: Jia Xu, Hoboken, NJ (US)

(21) Appl. No.: 18/809,234

(22) Filed: Aug. 19, 2024

Related U.S. Application Data
(60) Provisional application No. 63/533,492, filed on Aug. 18, 2023.

(51) Int. Cl. H04L 51/02; G06T 13/20; G06T 13/40

(52) U.S. Cl. CPC H04L 51/02; G06T 13/205; G06T 13/40

(57) ABSTRACT

A method for operating a chatbot receives, with a chatbot interface, an avatar identification input configured to identify a person. The method generates a three-dimensional avatar based on the avatar identification input. The method renders, with the chatbot interface, the three-dimensional avatar. The method determines a verbal output in response to receiving a verbal input from a user. The method outputs, with the chatbot interface, an avatar audio output after determining the verbal output. The method renders, with the chatbot interface, a series of avatar movements using the three-dimensional avatar while outputting the avatar audio output.

### PRIORITY

This patent application claims priority from provisional U.S. patent application No. 63/533,492, filed Aug. 18, 2023, entitled, “PERSONALIZED AVATAR DESIGN IN CHATBOT,” and naming Jia Xu as inventor, the disclosure of which is incorporated herein, in its entirety, by reference.

### FIELD

Illustrative embodiments of the invention generally relate to conversational interfaces and, more particularly, various embodiments of the invention relate to personalizing avatars for a chatbot.

### BACKGROUND

Chatbots have facilitated digital communications by mimicking human-like interactions through text and voice responses. Chatbots may serve a variety of functions from customer service to personal assistance on various digital platforms.

### SUMMARY OF VARIOUS EMBODIMENTS

In accordance with one embodiment of the invention, a method for operating a chatbot receives, with a chatbot interface, an avatar identification input configured to identify a person. The method generates a three-dimensional avatar based on the avatar identification input. The method renders, with the chatbot interface, the three-dimensional avatar. The method determines a verbal output in response to receiving a verbal input from a user. The method outputs, with the chatbot interface, an avatar audio output after determining the verbal output. The method renders, with the chatbot interface, a series of avatar movements using the three-dimensional avatar while outputting the avatar audio output.

The avatar identification input may include at least one of an image or a name. The avatar identification input may include a name, and receiving the avatar identification input may include requesting an image of the person corresponding to the name, and receiving the image.

The three-dimensional avatar may be a virtual representation of the person.

The series of avatar movements may include lip movements synchronized to the avatar audio output.

In some embodiments, the method selects, using the chatbot interface, a synthesized voice as a function of a characteristic of the three-dimensional avatar. The characteristic may be age or gender.

The verbal output may include a content violation notification.

In some embodiments, the method integrates the three-dimensional avatar into a virtual or augmented reality environment, whereby the three-dimensional avatar interacts with the user in real-time.

Rendering the series of avatar movements may include rendering gestures or facial expressions in response to the verbal input.

Illustrative embodiments of the invention are implemented as a computer program product having a computer usable medium with computer readable program code thereon. The computer readable code may be read and utilized by a computer system in accordance with conventional processes.

### BRIEF DESCRIPTION OF THE DRAWINGS

Those skilled in the art should more fully appreciate advantages of various embodiments of the invention from the following “Description of Illustrative Embodiments,” discussed with reference to the drawings summarized immediately below.

FIG. 1 is a flowchart showing a process for personalizing a chatbot avatar in accordance with various embodiments.

FIG. 2 schematically shows a chatbot interface in accordance with various embodiments.

FIG. 3 is a block diagram of a computing device in accordance with various embodiments.

### DESCRIPTION OF ILLUSTRATIVE EMBODIMENTS

In illustrative embodiments, a chatbot displays a personalized avatar. A user submits information about a person and the avatar is updated to resemble the person. As the chatbot determines output to communicate to the user, the avatar is rendered to speak the output to the user.

The personalized avatar described herein represents a significant technical advancement over conventional user interface technologies. By integrating complex algorithms for facial recognition and three-dimensional modeling, the system transforms a two-dimensional image or a user-provided name into an interactive, animated avatar. These avatars possess an ability to mimic nuanced human expressions and gestures, leading to more engaging and natural user interactions. This enhanced level of interaction is not merely cosmetic; it is underpinned by a set of non-obvious technical processes that include generating lifelike lip movements synchronized with user-specific voice outputs, thus providing a transformative user experience that goes beyond the mere presentation of information or routine animation.

Concrete improvements in user interface systems are exemplified through the avatar's sophisticated interaction framework. The technical contribution lies in the avatar's real-time responsive movements and expressions, which are tailored to the context of the user's input, greatly improving the usability and accessibility of virtual interactions. The avatar's unique capability to adapt its response based on environmental cues—such as adjusting dialogue volume in response to ambient sound or refining its expressions based on the emotional tone of user input—demonstrates a specific application of artificial intelligence: a clearly defined implementation of a technical solution that enhances user engagement in a measurable way.

Furthermore, the avatar's integration into various practical applications underscores its technical novelty. It operates seamlessly within virtual and augmented reality settings, providing interactive experiences that are deeply immersive. In educational environments, the avatar facilitates learning through personalized interactions, responding and adapting to individual learning styles. In customer service applications, it offers a humanized interface that can express empathy and react appropriately to customer queries, providing a service that is both technically sophisticated and tailored to the nuanced demands of human communication. Each of these applications serves as a tangible example of how the personalized avatar extends beyond a mere abstraction to provide concrete, tangible technical benefits that are clearly defined and markedly different from generic user interfaces. Details of illustrative embodiments are discussed below.

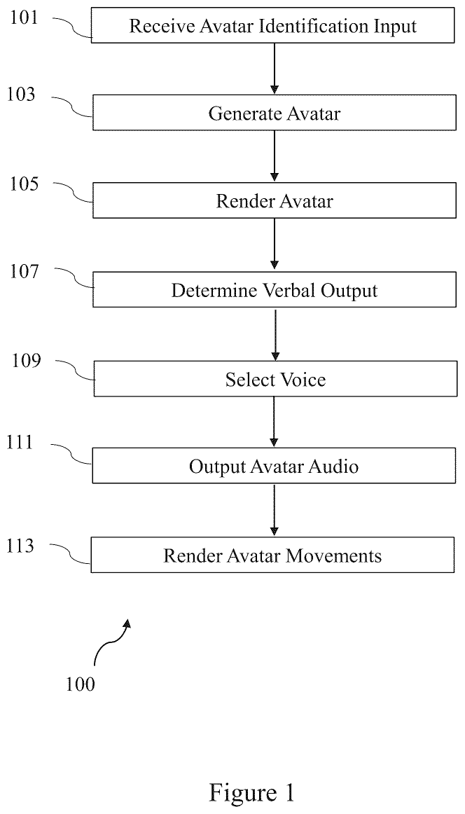

FIG. 1 shows an exemplary process 100 for operating a chatbot in accordance with the illustrative embodiment. The process 100 may be implemented in whole or in part in one or more of the computing devices disclosed herein. In certain forms, the functionalities may be performed by separate devices. In certain forms, all functionalities may be performed by the same device. It should be further appreciated that a number of variations and modifications to the process 100 are contemplated including, for example, the omission of one or more aspects of the process 100, the addition of further conditionals and operations, or the reorganization or separation of operations and conditionals into separate processes.

The process 100 begins by receiving an avatar identification input from a user. The avatar identification input is configured to identify a person. The avatar identification input may be a name or an image, among other things. Where the avatar identification input is not an image, receiving the avatar identification input may include performing a search for an image using the avatar identification input. The search may be conducted, among other things, by way of an internet search engine or a database query.

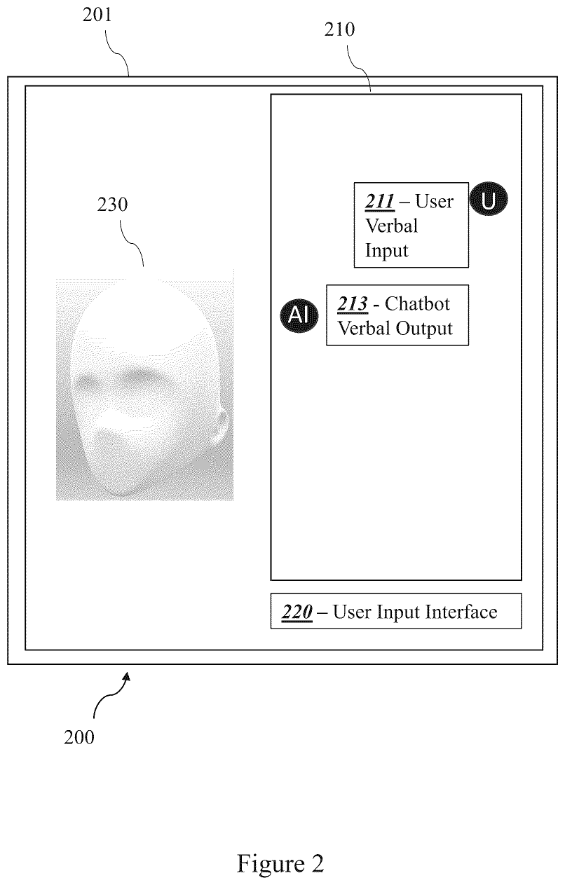

As shown in FIG. 2, the user inputs the avatar identification input by way of a chatbot interface 200 displayed on a screen 201. The chatbot interface 200 includes a conversation section 210 configured to display verbal communications between the user and the chatbot. The communications include user verbal inputs 211 from the user and chatbot verbal outputs 213 from the chatbot. The user input interface 220 may receive input from the user. For example, the user may enter the user verbal input 211, an audio recording, or an image (i.e., avatar identification input), among other things. The chatbot interface also includes an avatar section 230 configured to display the personalized avatar.

After receiving the image in operation 101, the process 100 proceeds to operation 102 where the process 100 generates the avatar. The process 100 may generate a two-dimensional or three-dimensional avatar based on the image. The process 100 may generate the avatar using, among other things, photogrammetry, structure from motion (SFM), multi-view stereo (MVS), volumetric reconstruction, neural networks/deep learning, space carving, depth map estimation, or single image 3d reconstruction.

The process 100 then renders the avatar in the avatar section 230 of the chatbot interface 200. The rendering of the avatar may be two dimensional or three dimensional. In some embodiments, the process 100 renders the avatar by integrating the avatar into a virtual or augmented reality environment, allowing the avatar to interact with the user in real-time.

The process 100 determines a verbal output in response to receiving a verbal input from a user in operation 107. The process 100 may determine the verbal output using, among other things, rule-based responses, template-based responses, retrieval-based models, generative models, hybrid models, contextual and memory-based models, reinforcement learning, knowledge-based models, natural language understanding (NLU) enhanced models, or sentiment analysis-based responses.

In some embodiments, the verbal output includes a content violation notification which communicates that the input to the chatbot from the user has violated a rule. In some embodiments, the verbal output includes another type of notification determined in response to the user input.

The process 100 selects a synthesized voice for outputting the speech of the avatar. In some embodiments, the voice is selected based on the avatar. For example, the voice may be selected based on an age or gender characteristic of the avatar, such as selecting a voice corresponding to a man, a woman, a boy, or a girl. In some embodiments, the characteristic is a personality type. In some embodiments, the user may upload an audio recording of the person and the process 100 will synthesize a voice using, among other things, speech signal processing and feature extraction, mel-frequency cepstral coefficients (MFCCs), linear predictive coding (LPC), deep learning models (e.g., CNNs, RNNs), voiceprint recognition (speaker identification), formant analysis, pitch analysis, spectrogram analysis, phoneme-based profiling, prosody analysis, vocal tract length normalization (VTLN), gaussian mixture models (GMMs), i-vectors and x-vectors, wavelet transform, or voice biometrics systems.

After the synthesized voice is selected and the verbal output is determined, the process 100 outputs the avatar audio output using the chatbot interface in operation 111.

While the process 100 is outputting the avatar audio output, the process 100 simultaneously renders a series of avatar movements using the avatar in the avatar section 230. The series of avatar movements may include body movement, gestures, facial expressions, poses, or lip movements which are rendered in response to the user input. The pose of the person can also be changed based on the context of the conversation. In some embodiments, the lip movements are synchronized to the avatar audio output to appear as if the avatar is speaking the words of the avatar audio output. The lips may be synchronized to the audio using, among other things, DeepFaceLab, Adobe Character Animator, NVIDIA Omniverse Audio2Face, viseme-based animation systems, Faceware Studio, JALI (joint audio-text driven facial animation), Microsoft Azure Speech API with lip sync, Canny AI's VDub (video dub), Speech Graphics, or Reallusion iClone lip sync animation.

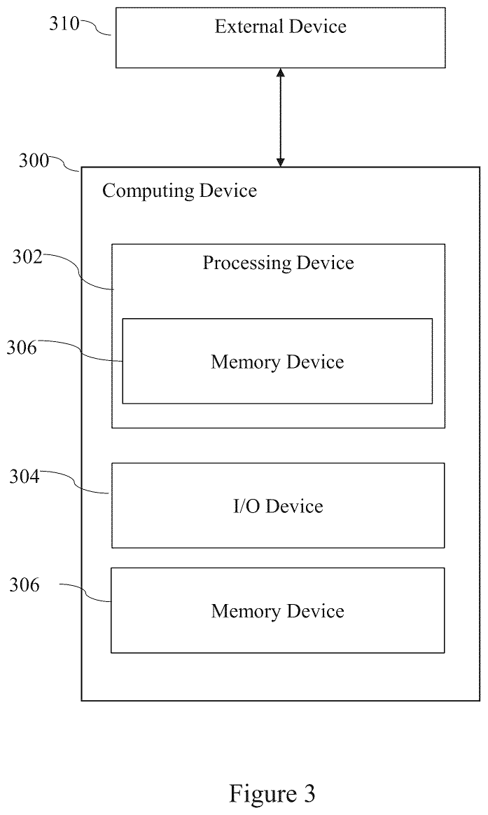

FIG. 3 schematically shows a computing device 300 in accordance with various embodiments. The computing device 300 is one example of a computing device which is used to perform one or more operations of process 100 illustrated in FIG. 1. Among other things, the computing device 300 may include a mobile phone, television, a device configured to display a virtual or augmented reality environment, or another type of device having a screen configured to display the chatbot interface 200 illustrated in FIG. 2. The computing device 300 includes a processing device 302, an input/output device 304, and a memory device 306. The computing device 300 may be a stand-alone device, an embedded system, or a plurality of devices configured to perform the functions described with respect to the process 100. Furthermore, the computing device 300 may communicate with one or more external devices 310.

The input/output device 304 enables the computing device 300 to communicate with an external device 310. For example, the input/output device 304 may be a network adapter, a network credential, an interface, or a port (e.g., a USB port, serial port, parallel port, an analog port, a digital port, VGA, DVI, HDMI, FireWire, CAT 5, Ethernet, fiber, or any other type of port or interface), among other things. The input/output device 304 may be comprised of hardware, software, or firmware. The input/output device 304 may have more than one of these adapters, credentials, interfaces, or ports, such as a first port for receiving data and a second port for transmitting data, among other things.

The external device 310 may be any type of device that allows data to be input or output from the computing device 300. For example, the external device 310 may be a database stored on another computer device, a meter, a control system, a sensor, a mobile device, a reader device, equipment, a handheld computer, a diagnostic tool, a controller, a computer, a server, a printer, a display, a visual indicator, a keyboard, a mouse, or a touch screen display, among other things. Furthermore, the external device 310 may be integrated into the computing device 300. More than one external device may be in communication with the computing device 300.

The processing device 302 may be a programmable type, a dedicated, hardwired state machine, or a combination thereof. The processing device 302 may further include multiple processors, Arithmetic-Logic Units (ALUs), Central Processing Units (CPUs), Digital Signal Processors (DSPs), or Field-programmable Gate Arrays (FPGA), among other things. For forms of the processing device 302 with multiple processing units, distributed, pipelined, or parallel processing may be used. The processing device 302 may be dedicated to performance of just the operations described herein or may be used in one or more additional applications. The processing device 302 may be of a programmable variety that executes processes and processes data in accordance with programming instructions (such as software or firmware) stored in the memory device 306. Alternatively or additionally, programming instructions are at least partially defined by hardwired logic or other hardware. The processing device 302 may be comprised of one or more components of any type suitable to process the signals received from the input/output device 304 or elsewhere, and provide desired output signals. Such components may include digital circuitry, analog circuitry, or a combination thereof.

The memory device 306 in different embodiments may be of one or more types, such as a solid-state variety, electromagnetic variety, optical variety, or a combination of these forms, to name but a few examples. Furthermore, the memory device 306 may be volatile, nonvolatile, transitory, non-transitory or a combination of these types, and some or all of the memory device 306 may be of a portable variety, such as a disk, tape, memory stick, or cartridge, to name but a few examples. In addition, the memory device 306 may store data which is manipulated by the processing device 302, such as data representative of signals received from or sent to the input/output device 304 in addition to or in lieu of storing programming instructions, among other things. As shown in FIG. 3, the memory device 306 may be included with the processing device 302 or coupled to the processing device 302, but need not be included with both.

It is contemplated that the various aspects, features, processes, and operations from the various embodiments may be used in any of the other embodiments unless expressly stated to the contrary. Certain operations illustrated may be implemented by a computer executing a computer program product on a non-transient, computer-readable storage medium, where the computer program product includes instructions causing the computer to execute one or more of the operations, or to issue commands to other devices to execute one or more operations.

While the present disclosure has been illustrated and described in detail in the drawings and foregoing description, the same is to be considered as illustrative and not restrictive in character, it being understood that only certain exemplary embodiments have been shown and described, and that all changes and modifications that come within the spirit of the present disclosure are desired to be protected. It should be understood that while the use of words such as “preferable,” “preferably,” “preferred” or “more preferred” utilized in the description above indicate that the feature so described may be more desirable, it nonetheless may not be necessary, and embodiments lacking the same may be contemplated as within the scope of the present disclosure, the scope being defined by the claims that follow. In reading the claims, it is intended that when words such as “a,” “an,” “at least one,” or “at least one portion” are used there is no intention to limit the claim to only one item unless specifically stated to the contrary in the claim. The term “of” may connote an association with, or a connection to, another item, as well as a belonging to, or a connection with, the other item as informed by the context in which it is used. The terms “coupled to,” “coupled with” and the like include indirect connection and coupling, and further include but do not require a direct coupling or connection unless expressly indicated to the contrary. When the language “at least a portion” or “a portion” is used, the item can include a portion or the entire item unless specifically stated to the contrary. Unless stated explicitly to the contrary, the terms “or” and “and/or” in a list of two or more list items may connote an individual list item, or a combination of list items. Unless stated explicitly to the contrary, the transitional term “having” is open-ended terminology, bearing the same meaning as the transitional term “comprising.”

Various embodiments of the invention may be implemented at least in part in any conventional computer programming language. For example, some embodiments may be implemented in a procedural programming language (e.g., “C”), or in an object-oriented programming language (e.g., “C++”). Other embodiments of the invention may be implemented as a pre-configured, stand-alone hardware element and/or as preprogrammed hardware elements (e.g., application specific integrated circuits, FPGAs, and digital signal processors), or other related components.

In an alternative embodiment, the disclosed apparatus and methods (e.g., see the various flow charts described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. Such variations and modifications are intended to be within the scope of the present invention as defined by any of the appended claims. It shall nevertheless be understood that no limitation of the scope of the present disclosure is hereby created, and that the present disclosure includes and protects such alterations, modifications, and further applications of the exemplary embodiments as would occur to one skilled in the art with the benefit of the present disclosure.

What is claimed is:

1. A method for operating a chatbot, comprising:
receiving, with a chatbot interface, an avatar identification input configured to identify a person;
generating a three-dimensional avatar based on the avatar identification input;
rendering, with the chatbot interface, the three-dimensional avatar;
determining a verbal output in response to receiving a verbal input from a user;
outputting, with the chatbot interface, an avatar audio output after determining the verbal output; and
rendering, with the chatbot interface, a series of avatar movements using the three-dimensional avatar while outputting the avatar audio output.

2. The method of claim 1, wherein the avatar identification input includes at least one of an image or a name.

3. The method of claim 1, wherein the avatar identification input includes a name, and wherein receiving the avatar identification input includes requesting an image of the person corresponding to the name, and receiving the image.

4. The method of claim 1, wherein the three-dimensional avatar is a virtual representation of the person.

5. The method of claim 1, wherein the series of avatar movements includes lip movements synchronized to the avatar audio output.

6. The method of claim 1, comprising selecting, using the chatbot interface, a synthesized voice as a function of a characteristic of the three-dimensional avatar.

7. The method of claim 6, wherein the characteristic is age or gender.

8. The method of claim 1, wherein the verbal output includes a content violation notification.

9. The method of claim 1, further comprising integrating the three-dimensional avatar into a virtual or augmented reality environment, whereby the three-dimensional avatar interacts with the user in real-time.

10. The method of claim 1, wherein rendering the series of avatar movements further includes rendering gestures or facial expressions in response to the verbal input.

11. A computer program product for use on a computer system for operating a chatbot, the computer program product comprising a tangible, non-transient computer usable medium having computer readable program code thereon, the computer readable program code comprising:
program code for receiving, with a chatbot interface, an avatar identification input configured to identify a person;
program code for generating a three-dimensional avatar based on the avatar identification input;
program code for rendering, with the chatbot interface, the three-dimensional avatar;
program code for determining a verbal output in response to receiving a verbal input from a user;
program code for outputting, with the chatbot interface, an avatar audio output after determining the verbal output; and
program code for rendering, with the chatbot interface, a series of avatar movements using the three-dimensional avatar while outputting the avatar audio output.

12. The computer program product of claim 11, wherein the avatar identification input includes at least one of an image or a name.

13. The computer program product of claim 11, wherein the avatar identification input includes a name, and wherein receiving the avatar identification input includes requesting an image of the person corresponding to the name, and receiving the image.

14. The computer program product of claim 11, wherein the three-dimensional avatar is a virtual representation of the person.

15. The computer program product of claim 11, wherein the series of avatar movements includes lip movements synchronized to the avatar audio output.

16. The computer program product of claim 11, comprising program code for selecting, using the chatbot interface, a synthesized voice as a function of a characteristic of the three-dimensional avatar.

17. The computer program product of claim 16, wherein the characteristic is age or gender.

18. The computer program product of claim 11, wherein the verbal output includes a content violation notification.

19. The computer program product of claim 11, further comprising program code for integrating the three-dimensional avatar into a virtual or augmented reality environment, whereby the three-dimensional avatar interacts with the user in real-time.

20. The computer program product of claim 11, wherein rendering the series of avatar movements further includes rendering gestures or facial expressions in response to the verbal input.
